(19) United States
(12) Patent Application Publication
(10) Pub. No.: US 2014/0237059 A1
(43) Pub. Date: Aug. 21, 2014

(54) Message Status per Recipient Method and Devices

(71) Applicant: INFINITE CONVERGENCE SOLUTIONS, INC., Arlington Heights, IL (US)

(72) Inventor: Michael Duda, Naperville, IL (US)

(21) Appl. No.: 14/183,288

(22) Filed: Feb. 18, 2014

Related U.S. Application Data
(60) Provisional application No. 61/767,699, filed on Feb. 21, 2013.

(51) Int. Cl. H04L 12/58

(52) U.S. Cl. CPC H04L 51/34
USPC 709/206

(57) ABSTRACT

This provides a method and devices to store the recipient status of all recipients of a message and makes the recipient status available from a network server to multiple client devices.

### CROSS-REFERENCE TO RELATED APPLICATIONS

This application claims the benefit of U.S. Provisional application 61/767,699 filed on Feb. 22, 2013 by the present inventor. Provisional Application 61/767,699 is incorporated by reference into this application.

### FEDERALLY SPONSORED RESEARCH

None.

### SEQUENCE LISTING

None.

### FIELD OF THE INVENTION

This invention relates to status reporting of Electronic Messages delivered to email, mobile devices and web browsers.

### BACKGROUND OF THE INVENTION

Senders of mobile messages currently have visibility to delivery status of messages on their mobile device. The status often includes indicators that represent ‘read’ or ‘received’ or ‘delivered’ or other custom status. However the user sometimes has multiple ways to access their message content which in the preferred embodiment includes mobile devices but also includes tablets and web browsers. While the recipient status is sometimes available to the sending device for a single recipient, the recipient status for all recipients is not available to other devices owned by the same user and the status is not available for when there are multiple recipients of the message.

### SUMMARY OF INVENTION

This provides the recipient status of each message for each recipient of the message and makes the recipient status available to multiple client devices. The recipient status for all recipients is stored as an attribute for each message.

### DRAWINGS

### List of Reference Numbers

110 Client device capable of originating an MMS formatted message, email or other electronic message and storing, retrieving and displaying the recipient status of all recipients of the message in the Message Storage Application.
120 A multimedia message service center (MMSC) enhanced to support message storage commands to and from another server. A multimedia message service center enhanced to support creating and receiving recipient status from a client device capable of updating recipient status of all recipients in the Message Storage Application.
130 Client device capable of terminating an MMS formatted message, email or other electronic message.
140 A Message Storage Application that stores messages, status of recipients for each message and communicates with other apparatus regarding the status of all recipients of every message.
210 Client device capable of originating an SMS formatted message, email or other electronic message and storing, retrieving and displaying the recipient status of all recipients of the message in the Message Storage Application.
220 A short message service center enhanced to support message storage commands to and from another server. A short message service center enhanced to support creating and receiving recipient status from a client device. Capable of updating recipient status of all recipients in the Message Storage Application.
230 Client device capable of terminating an SMS formatted message, email or other electronic message and capable of updating status information for each message received.
310 A client capable of retrieving and displaying the status of all recipients of a given message.
320 Client device capable of terminating an SMS formatted message email or other electronic message. Capable of updating status information for each message received.

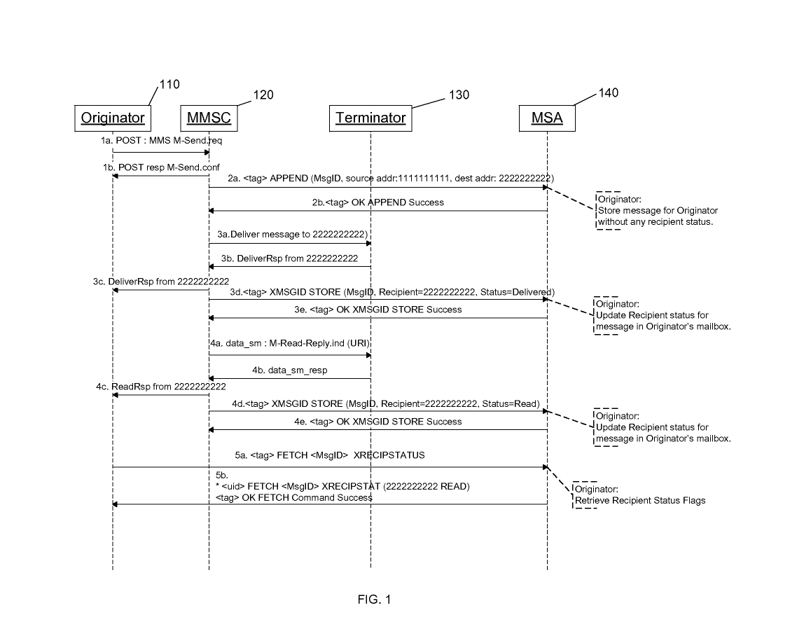

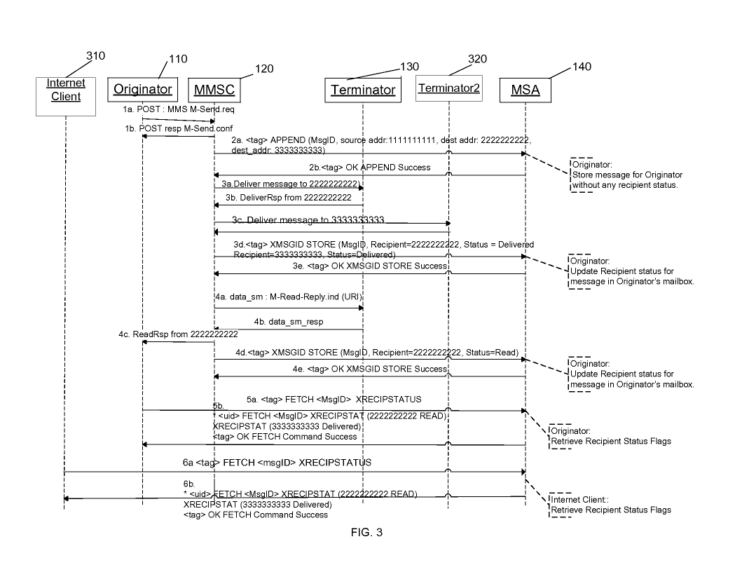

GLOSSARY

| | |
|---|---|
| 1111111111 | Mobile directory number of client device |
| | (originator of message in FIG. 1) |
| 2222222222 | Mobile directory number of client device |
| | (terminator of message in FIG. 1) |
| 3333333333 | Mobile directory number of client device |
| | (termintor2 of message in FIG. 3) |
| APPEND | An message to initiate storage of a new message |
| CLIENT | Software that accesses a remote service on another |
| | computer. |
| IETF | Internet Engineering Task Force |
| IMAP | Internet Message Access Protocol |
| FETCH | IMAP Command which can be enhanced to obtain |
| | recipient status of every recipient of a given |
| | message. |
| Internet Client | Internet Protocol based Client that accesses data on |
| | the message Including for example a cellular |
| | operator' webpage. |
| IP | Internet Protocol |
| MDNA | Mobile Directory Number ‘A’ |
| MDNB | Mobile Directory Number ‘B’ |
| MMSC | MultiMedia Message Center |
| MSA | Message Storage Application or alternately called a |
| | Message Storage Application, a Server that stores |
| | messages as well as status of recipients of the |
| | message and transmits the status of the messages to |
| | multiple client devices |
| MsgID | Unique identifier of a message |
| Originator | A mobile device client that initiates a message |
| RCS | Rich Communications Suite |
| RFC | IETF Request for Comments Document |
| SMSC | Short Message Service Center |
| SMTP | Simple Mail Transfer Protocol |
| Terminator | A mobile device client including a legacy phone, a |
| | smart phone or a tablet device that is a recipient |
| | of a message |
| Terminator2 | A second mobile device client that is a recipient of a |
| | message |
| UID | Unique Identifier for each message, assigned in a |
| | strictly ascending fashion but not necessarily |
| | contiguous. |
| XMSGID STORE | Newly added command that stores status of message |
| | for one or more recipients to remote server. |
| XRECIPIENSTAT | newly added parameter to IMAP FETCH command |
| | which is used to report recipient status on one |
| | or more recipients. |

### BRIEF DESCRIPTION OF DRAWINGS

FIG. 1 shows the originator client device sending a multimedia message to the terminator device via the MMSC using commands well known in the art. The message and MMSC message ID are stored in the MSA device. Once the message is delivered to the terminator client, the recipient status of the message along with a recipient identifier is stored in the MSA and is updated to show the status equals ‘Delivered’ to mobile 2222222222 using a new command XMSGID STORE. The message is then read by the terminator device 2222222222 and the recipient status at the MSA server is updated again to indicate ‘READ’ once again using the new command XMSGID STORE. The recipient status of the message is then returned to the Originator device (or another client device with permission to access the information) at a later time via the FETCH command and the new XRECIPSTAT parameter of the FETCH command.

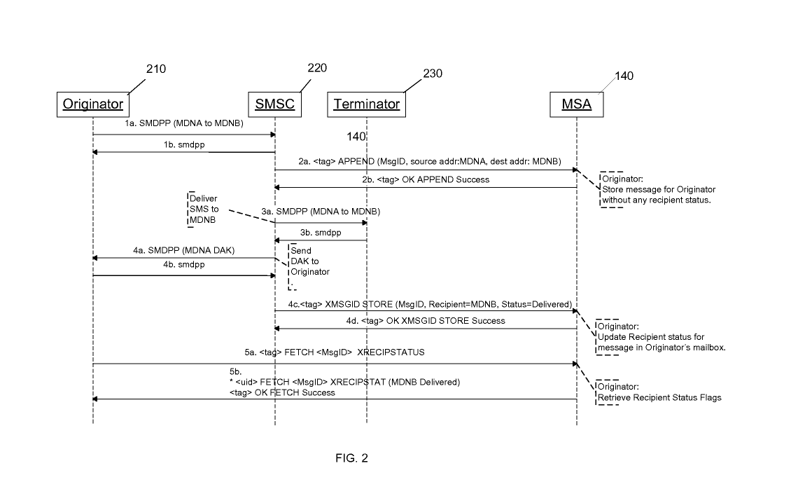

FIG. 2 shows the Originator client device with Mobile Directory Number MDNA sending a short message to the terminator device with Mobile Directory Number MDNB via an SMSC using commands well known in the art. The message is initially stored in the MSA device. Once delivered, the recipient status of the message is stored in the MSA and is updated to show the recipient status equals ‘Delivered’ to mobile MDNB using the new command XMSGID STORE. The recipient status of the message is then returned to the Originator device at a later time via the FETCH command and the new XRECIPSTAT parameter of the FETCH command.

FIG. 3 shows the originator client device with MDN 1111111111 sending a multimedia message to both a Terminator device with MDN 2222222222 and a Terminator 2 device with MDN 3333333333 via the MMSC using commands well known in the art. The unique msgID and recipient status of the message is initially stored in the MSA. Once the recipient status of the message with respect to any recipient changes, the MSA is updated to show the recipient status equals ‘Delivered’ to mobile 2222222222 using the new command XMSGID STORE. The message is then read by the terminator device 2222222222 and the recipient status at the MSA server is updated again to indicate ‘READ’ once again using the new command XMSGID STORE. The recipient status of the message is then returned to the Originator device at a later time via the FETCH command and the new XRECIPSTAT parameter of the FETCH command.

FIG. 3 then shows the information on the MSA being accessed by an Internet client, which includes, for example, a cellular operator's customer accessible webpage.

### DETAILED DESCRIPTION

When a messaging or email client sends a message, a copy is stored at a new network storage device, a Message Storage Apparatus, alternately called a Message Storage Application which stores the message as well as the recipient status of the message for each recipient. Initially the recipient status for each recipient is not set or alternately set to “None” since message has just been sent. In the preferred embodiment, this initial setting can be done with an IMAP APPEND command. As other network servers, such as the SMSC or MMSC are informed of delivery status for each recipient, these recipient status notifications are sent to the Mobile Storage Application device via the XMSGID STORE command to update the appropriate recipient status for each recipient.

Those with skill in the art will recognize that MSA can be a separate device or additional functionality added to an industry standard SMSC or MMSC or RCS server. Since this status is now managed at a network storage device, the delivery status of a message for each recipient can be seen by any permitted client device such as multiple mobiles owned by the same customer, a tablet and a web browser which all can access synchronized information for a given message id at a shared server.

In the preferred embodiment, a new command XMSGID STORE, is used by the SMSC or MMSC or RCS server to store messages to a separate message server device. At a later time, a client such as a cellular phone, smartphone or tablet, or web-browser can access the recipient status of one or more recipients of a given message using a modified FETCH command which is modified by the inventor to include a XRECIPIENTSTATUS parameter.

What is claimed is:

1. A method to receive, store and transmit the recipient status of mobile messages and email messages received from either an internet client or a mobile client device comprising: storing a copy of the sent message on a message storage apparatus; initializing the recipient status of each recipient of each message; receiving the recipient status of recipients of the message; storing the recipient status of each recipient on the storage apparatus; receiving a query from a client device to report the recipient status of one or more recipients of a given message; sending the recipient status of each recipient of a given message to either a mobile device client or an internet client.

2. The method of claim 1 where the recipient status comprises s a message read indicator.

3. The method of claim 1 where the recipient status comprises a message delivery indicator.

4. The method of claim 1 where the recipient status comprises a “failed” indicator.

5. The method of claim 1 where the recipient status comprises an “Unknown” indicator.

6. The method of claim 1 where the recipient status is first transmitted by a mobile client device to either a MMSC, an SMSC, or an RCS Server and then forwarded to a message storage apparatus and sent by the storage apparatus to an internet client.

7. The method of claim 1 where the recipient status is transmitted by an internet client to a message server apparatus and sent by the server apparatus to a mobile client.

8. The method of claim 1 where mobile messages comprise cellular MMS messages.

9. The method of claim 1 where the mobile messages comprise cellular SMS messages.

10. The method of claim 1 where the email message comprise an SMTP formatted email message.

11. The method of claim 1 where the internet client comprises a web browser.

12. The method of claim 1 where the mobile device client comprises a tablet device.

13. The method of claim 1 where the mobile device client comprises a legacy cellular phone.

14. The method of claim 1 where the mobile device client comprises a smart phone.

15. A message storage apparatus which stores email messages and mobile messages and additional information comprising the recipient status of all recipients of each message.

16. The message storage apparatus of claim 15 whereby recipient status of one or more recipients of a message to both mobile clients and internet clients is transmitted via proprietary IMAP messages.

17. A mobile client device including but not limited to a mobile phone or a tablet device whereby the recipient status of mobile messages previously sent by another client device is retrieved and displayed.
